(19) United States
(12) Patent Application Publication
(10) Pub. No.: US 2022/0226829 A1
(43) Pub. Date: Jul. 21, 2022

(54) SYSTEMS FOR PERFORMING CELLULAR ANALYSIS AND RELATED DEVICES FOR CONDITIONING ENVIRONMENTS ADJACENT CHIPS IN SUCH SYSTEMS

(71) Applicant: Amgen Inc., Thousand Oaks, CA (US)

(72) Inventors: Craig Michael SCHULZ, Thousand Oaks, CA (US); Justin James PROVCHY, Simi Valley, CA (US); Aaron George WINTERS, Ventura, CA (US)

(21) Appl. No.: 17/616,616

(22) PCT Filed: Jun. 4, 2020
(86) PCT No.: PCT/US2020/036178

§ 371 Date: Dec. 3, 2021

Related U.S. Application Data
(60) Provisional application No. 62/857,565, filed on Jun. 5, 2019.

(51) Int. Cl. B01L 5/00

(52) U.S. Cl. CPC B01L 5/00; B01L 2200/026; B01L 2200/0684; B01L 2300/0663; B01L 2300/048; B01L 2300/0609; B01L 2300/10; B01L 2200/14

(57) ABSTRACT

Systems for performing cellular analysis and related devices for conditioning environments adjacent chips in such systems. A device for conditioning an environment adjacent a chip in a system for performing cellular analysis, the device includes a cover for being disposed adjacent the chip and comprising a planar body having a top surface, a bottom surface, and an outer edge surface. The cover includes a central opening extending between the top surface and the bottom surface and bounded by an inner edge surface of the cover. The cover also includes a fluid inlet extending into the body from the outer edge surface between the top surface and the bottom surface the fluid inlet arranged to accept a gas to be delivered to the central opening. The cover also includes a plurality of fluid outlets defined in the inner edge surface and in fluid communication with the fluid inlet. The plurality of fluid outlets are arranged to receive the gas from the fluid inlet and exhaust the gas into the central opening.

### FIELD OF THE DISCLOSURE

The present disclosure relates generally to systems for performing cellular analysis and, in particular, to systems for performing cellular analysis and related devices for conditioning environments adjacent chips in such systems.

### BACKGROUND

Systems for performing cellular analysis such as the Berkley Lights® Beacon® platform may be used to perform a variety of cellular analyses. These systems may include microfluidic devices that are used to process micro-objects such as biological cells. To select and move the biological cells, the systems sometimes include one or more optoelectric positioners.

The systems can maintain the temperature within the systems between about 2° C. and 60° C. Temperature is known to affect metabolic functioning of living cells. Maintaining the cells between 2° C. and 8° C. may reduce and/or halt certain functions such as protein secretion and receptor internalization.

### SUMMARY

In accordance with a first example, a device for conditioning an environment adjacent a chip in a system for performing cellular analysis includes a cover for being disposed adjacent the chip and including a planar body having a top surface, a bottom surface, and an outer edge surface. The cover includes a central opening extending between the top surface and the bottom surface and bounded by an inner edge surface of the cover. The cover also includes a fluid inlet extending into the body from the outer edge surface between the top surface and the bottom surface. The fluid inlet is arranged to accept a gas to be delivered to the central opening. The cover also includes a plurality of fluid outlets defined in the inner edge surface and in fluid communication with the fluid inlet. The plurality of fluid outlets are arranged to receive the gas from the fluid inlet and exhaust the gas into the central opening.

In accordance with a second example, a system for performing cellular analysis includes an enclosure. The system also includes an imaging system disposed within the enclosure. The system also includes a chip to carry cells for analysis within the enclosure and a chip clamp to clamp the chip in place. The system also includes a local air conditioner arranged to reduce humidity immediately adjacent the chip. The system also includes a controller to cause the imaging system to obtain imaging data of the cells on the chip.

In further accordance with the foregoing first and/or second examples, an apparatus and/or method may further include any one or more of the following:

In accordance with one example, the cover includes a first layer including the top surface and a second layer including the bottom surface.

In accordance with another example, the first layer defines the central opening and includes the inner edge.

In accordance with another example, the second layer includes inner walls that surround the central opening.

In accordance with another example, the fluid outlets are defined by the inner walls.

In accordance with another example, the fluid outlets are outwardly spaced relative to the inner edge of the central opening.

In accordance with another example, a mask portion of the first layer extends between the inner walls and the central opening. The mask portion and the inner walls defines a chamber that covers the chip.

In accordance with another example, a plurality of fluid channels are arranged between the first layer and the second layer. Respective ones of the fluid outlets are associated with the fluid channels.

In accordance with another example, the first layer and the second layer are positioned adjacent one another to form the fluid channels therebetween.

In accordance with another example, the cover includes a plurality of locating pins extending from the bottom surface. The locating pins are arranged to be received adjacent the chip.

In accordance with another example, further including a plurality of cover clips having slots that receive portions of the outer edge surface of the cover. The cover clips are to be arranged to secure the cover relative to the chip.

In accordance with another example, the cover includes a plurality of fasteners. The cover clips include slots. The fasteners are received within the slots.

In accordance with another example, the local air conditioner includes a cover. The cover is to be disposed adjacent the chip and defines a central opening. The imaging data of the cells to be obtained through the central opening.

In accordance with another example, the cover includes a planar body having a top surface, a bottom surface, and an outer edge. The central opening extends between the top surface and the bottom surface and defines an inner edge.

In accordance with another example, the cover further includes a fluid inlet extending into the body from the outer edge between the top surface and the bottom surface. The cover also includes a plurality of fluid outlets in communication with the fluid inlet and arranged to exhaust a gas out of the central opening.

In accordance with another example, the cover includes a first layer including the top surface and a second layer including the bottom surface. A plurality of fluid channels are arranged between the first layer and the second layer. Respective ones of the fluid outlets are associated with the fluid channels.

In accordance with another example, the first layer defines the central opening and includes the inner edge and the second layer includes inner walls that surround the central opening and define the fluid outlets. A mask portion of the first layer extends between the inner walls and the central opening and the inner walls defines a chamber that covers the chip.

In accordance with another example, further including a second chip to carry cells for analysis within the enclosure and a second chip clamp to clamp the second chip in place. The local air conditioner is arranged to reduce humidity immediately adjacent the second chip.

In accordance with another example, the local air conditioner includes a manifold arranged to direct a gas toward the chip and the second chip. The gas reduces the humidity immediately adjacent the chip and the second chip.

In accordance with another example, the present invention is directed to a method for improving the viability of cell which is to be subjected to optoelectronic positioning (OEP) comprising performing the OEP at a temperature below dew point such that the cell can be visualized while the cell is being loaded, wherein the device of the presently claimed invention is utilized in order to decrease condensation on a chip in a system for performing cellular analysis.

In accordance with another example, the OEP is performed at a temperature selected from the group consisting of about 3° C., about 4° C., about 5° C., about 6° C., about 7° C., about 8° C., about 9° C., about 10° C., about 10.5° C., about 11° C., about 12° C., about 13° C., about 14° C., about 15° C., about 16° C., about 17° C., about 18° C., about 19° C., about 20° C., about 21° C., and about 22° C.

### BRIEF DESCRIPTION OF THE DRAWINGS

FIG. 1 is a schematic illustration of a system for performing cellular analysis in accordance with a first disclosed example.

FIG. 2 is an illustration of a system for performing cellular analysis in accordance with a second disclosed example.

FIG. 3 illustrates an isometric bottom-view of a cover of a local air conditioner of the system of FIG. 2.

FIG. 4 illustrates a plan-bottom view of a first layer of the cover of FIG. 3.

FIG. 5 illustrates a plan-top view of the cover of FIG. 3.

FIG. 6A illustrates an isometric bottom-up view of the cover and a plurality of cover clips. The cover clips are in a first position receiving an outer edge surface of the cover.

FIG. 6B illustrates an isometric bottom-up view of the cover and the cover clips in a second position receiving the outer edge surface of the cover.

FIG. 7A illustrates a chip having a plurality of wells that is covered by condensation and/or frost.

FIG. 7B illustrates the chip of FIG. 7A with the condensation and/or frost removed (or reduced) after using the example covers disclosed herein.

FIG. 8A shows that cold optoelectronic positioning (OEP) with claimed device enhances on-chip TCR T cell viability 18 hours after OEP.

FIG. 8B shows that cold OEP with claimed device enhances on-chip TCR T cell proliferation 96 hours after OEP.

### DETAILED DESCRIPTION

Although the following text discloses a detailed description of example methods, apparatus and/or articles of manufacture, it should be understood that the legal scope of the property right is defined by the words of the claims set forth at the end of this patent. Accordingly, the following detailed description is to be construed as examples only and does not describe every possible example, as describing every possible example would be impractical, if not impossible. Numerous alternative examples could be implemented, using either current technology or technology developed after the filing date of this patent. It is envisioned that such alternative examples would still fall within the scope of the claims.

The examples disclosed herein relate to systems and related devices for performing cellular analysis that reduce the likelihood of condensation forming when a temperature within the system is reduced below a dew point of the ambient air. If condensation forms within such systems, the quality of the imaging data may be reduced and may not be usable. Moreover, using the disclosed examples while operating the associated systems at lower temperatures allows for enhanced cell viability during manipulation workflows such as, for example, T cell work flows.

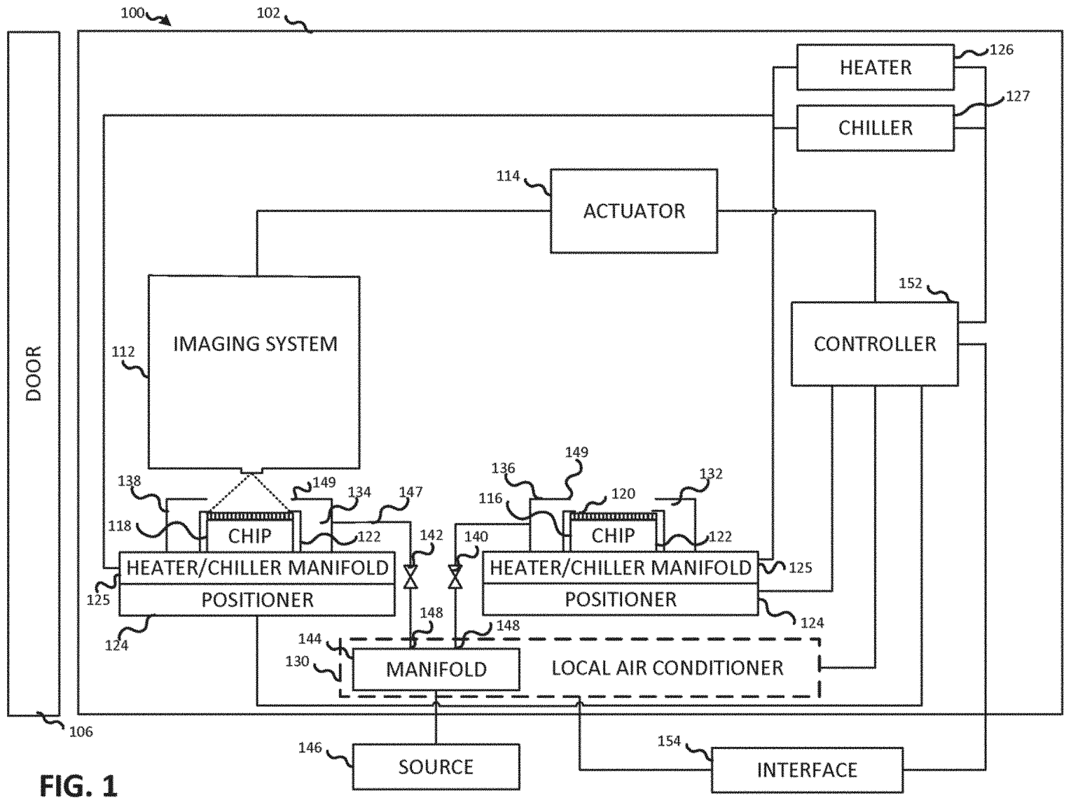

FIG. 1 is a schematic illustration of an example system 100 for performing cellular analysis in accordance with a first disclosed example. The system 100 includes an enclosure 102 that may be accessed and sealed via a door 106.

An imaging system 112, an actuator 114, and a plurality of chips 116, 118 are disposed in the enclosure 102. The imaging system 112 may include, for example, an optical train system, a LED light projector, etc. The imaging system 112 is configured to obtain imaging data and to perform fluorescence detection (e.g., cell counting) of cells carried by the chips 116, 118. The actuator 114 is configured to move the imaging system 112 from a position associated with obtaining imaging data from one of the chips 116 or 118 to a position associated with obtaining imaging data from another one of the chips 116 or 118. In the example shown, the imaging system 112 is positioned above the second chip 118 and, thus, is positioned to obtain imaging data associated with the second chip 118. Alternatively, the actuator 114 may be configured to move a platform (not shown) carrying the chips 116, 118 relative to the imaging system 112 that is stationary.

The chips 116, 118 are shown including a plurality of wells 120. The wells 120 may be used to isolate one or more cells for analysis and/or culturing. The wells 120 may be nanowells or microwells.

The system 100 also includes a plurality of chip clamps 122 and a plurality of positioners 124. The chip clamps 122 may be used to clamp the chips 116, 118 in place and the positioners 124 may be used to move one or more cells on the chips 116, 118 into and/or out of the wells 120. In the example shown, the chips 116, 118 are positioned on corresponding heater/chiller manifolds 125 that are coupled to a heater 126 and a chiller 127 of the system 100. The temperature of the chips 116, 118 may be controlled via the heater/chiller manifolds 125 by the heater 126 and the chiller 110. While the heater 108 and the chiller 110 are shown disposed within the space 104, the heater 126 and/or the chiller 127 may disposed outside of the space 104 but in communication with the space 104.

The system 100 also includes a local air conditioner 130. In the example shown, the local air conditioner 130 is configured to condition a plurality of environments 132, 134 (e.g., local environments) adjacent the chips 116, 118. Conditioning the environments 132, 134 may include reducing humidity adjacent the chips 116, 118 by providing dry air at a positive pressure. The dry air provided may decrease the humidity within the environments 132, 134 and reduce the likelihood of condensation forming on or around the chips 116, 118. As a result, even if the temperature within the enclosure 102 and/or the chips 116, 118 reaches the dew point of the ambient air, the local air conditioner 130 is configured to reduce the likelihood that condensation forms on the chips 116, 118, allowing for the acquisition of quality imaging data. Put another way, the local air conditioner 130 reduces the likelihood that a field of view (FOV) of the imaging system 112 is obscured via condensation and/or ice, allowing for the imaging system 112 to capture imaging data of a threshold amount of the wells 120 of the chip 116, 118. While dry air is mentioned, other gases may be used. Some of these gases have a lower boiling point such as, for example, Nitrogen (N) and Carbon Dioxide.

In the example shown, the local air conditioner 130 includes a plurality of covers 136, 138 (e.g., masks), a plurality of valves 140, 142, a manifold 144, and a source 146 of gas (e.g., dry compressed air). Flow lines 147 fluidly couple the covers 136, 138 and the valves 140, 142, the valves 140, 142 and the manifold 144, and the manifold 144 and the source 146. In practice, the source 146 flows the gas to the manifold 144 and the manifold 144 directs and distributes the gas through associated ports 148 of the manifold 144 and through the flow lines 147 toward the valves 140, 142 and to the covers 136, 138.

The covers 136, 138 may be integral to the respective chip clamps 122 or may be removably coupled to or adjacent to the chip clamps 122. Alternatively, the covers 136, 138 may be integrated into the system 100 in other ways that allow for the covers 136, 138 to condition the environments 132, 134.

As shown in FIG. 1, the covers 136, 138 define central openings 149 that allow the imaging system 112 to obtain imaging data of the chips 116, 118 and allow the gas provided by the source 146 to exhaust from the covers 136, 138. The valves 140, 142 are actuatable to selectively flow gas into the respective environments 132, 134. For example, when the imaging system 112 obtains imaging data of the second chip 118, the first valve 140 is closed and the second valve 142 is open. And, when the imaging system 112 obtains imaging data of the first chip 116, the second valve 142 is closed and the first valve 140 is open. In other versions, all valves 140, 142 remain open during imaging of all chips 116, 118 to ensure no condensation forms. The valves 140, 142 may be manually actuated by an operator or automatically actuated using, for example, a pneumatic or electric actuator controlled by a controller 152.

As seen in FIG. 1, the controller 152 includes an interface 154. The interface 154 is positioned outside of the enclosure 102 to allow for operator accessibility. In the example shown, the interface 154 is operatively coupled to the controller 152 and to the local air conditioner 130 and may be used to control the imaging system 112, the actuator 114, and the local air conditioner 130. Controlling the imaging system 112 includes causing the imaging system 112 to obtain imaging data of cells carried by one of the chips 116, 118. Controlling the actuator 114 includes causing the actuator 114 to move the imaging system 112 between a position associated with obtaining imaging data of the first chip 116 and a position associated with obtaining imaging data of the second chip 118. Controlling the local air conditioner 130 includes controlling the conditioning of the environments 132, 134. For example, the local air conditioner 130 may selectively reduce the humidity or otherwise condition the environments 132, 134 depending on a temperature within the enclosure 102 and/or a likelihood that condensation will form on or around the chips 116, 118.

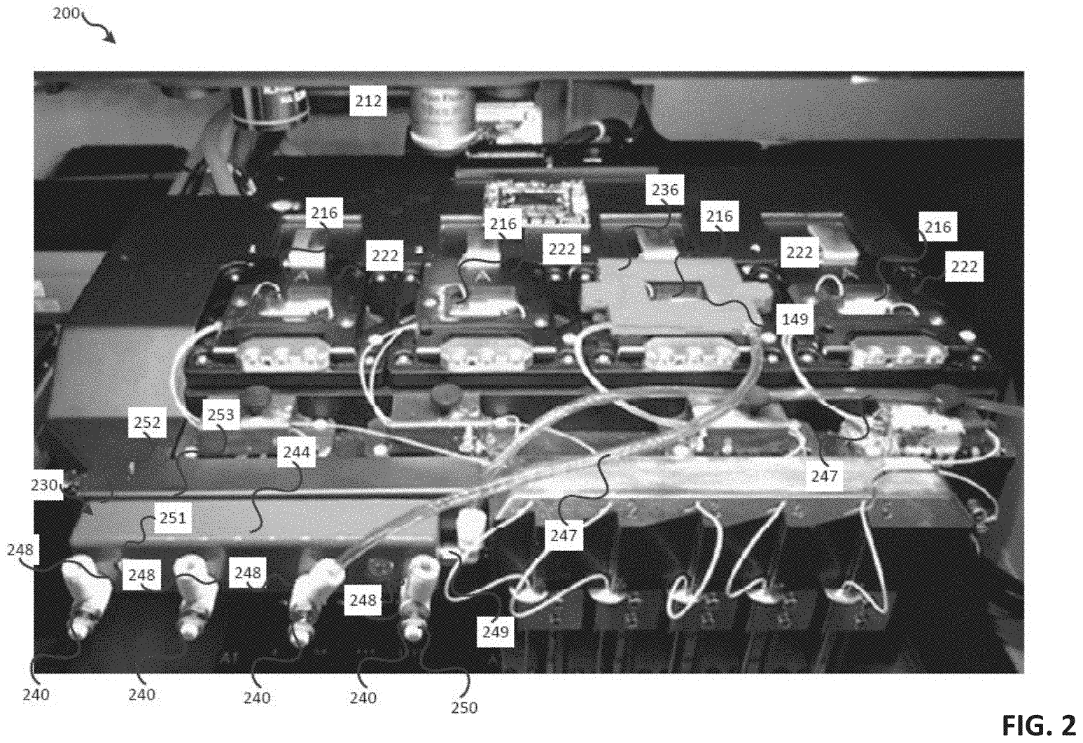

FIG. 2 is an illustration of an example system 200 for performing cellular analysis in accordance with a second disclosed example. The system 200 may be partially implemented by the Beacon® platform by Berkley Lights® and is similar to the system 100 of FIG. 1. Elements of the system 200 which are the same or similar to the system 100 are designated by the same reference numeral, incremented by 100 (e.g., the imaging system 112 and an imaging system 212). However, the system 200 is different from the system 100 of FIG. 1 in that four chips 216 are shown instead of two chips 116, 118 and four chip clamps 222 are shown instead of two. Also, a local air conditioner 230 of FIG. 2 includes a manifold 244 having four ports 248. The manifold 144 receives gas through a single inlet 249 and distributes the gas to the plurality of ports 248.

Four valves 240 are coupled to the ports 248 of the manifold 344 to selectively control gas flow out of the port 248, through flowlines 247, and to a cover 236. The valves 240 have manual actuators 250 formed by knobs that are rotatable to open and close (actuate) the valves 240. In other embodiments, the valves 240 may be actuated automatically by a system controller including memory and a processor executing logic programmed to open and close the valves 240 in accordance with a desired process routine. While FIG. 2 only shows one cover 236, alternative versions would have four covers 236, one per chip 216. Those covers may be formed of a single unit that cover all four of the chips 216 or may be formed on any number of units (e.g., 2, 3, 4) that cover the chips 216.

The manifold 244 is a cuboid (a rectangular prism) having the ports 248 disposed along one of the longer sides 251 and having an opposing one of the longer sides 252 positioned immediately adjacent and attached to a surface 253 of the system 200. The manifold 244 can be removably attached to the surface 253 of the system 200 using magnets, for example. The magnets may be received within one or more recesses of the manifold 244 and may be secured within the recesses using, for example, adhesive or the magnets themselves. FIG. 2 shows the cover 236 of the local air conditioner 230 positioned adjacent an associated one of the chips 216. However, alternatively, between one and four covers 236 (one per chip 216) may be included and the manifold 244 and the associated valves 240 may be used to selectively flow gas to those covers 236.

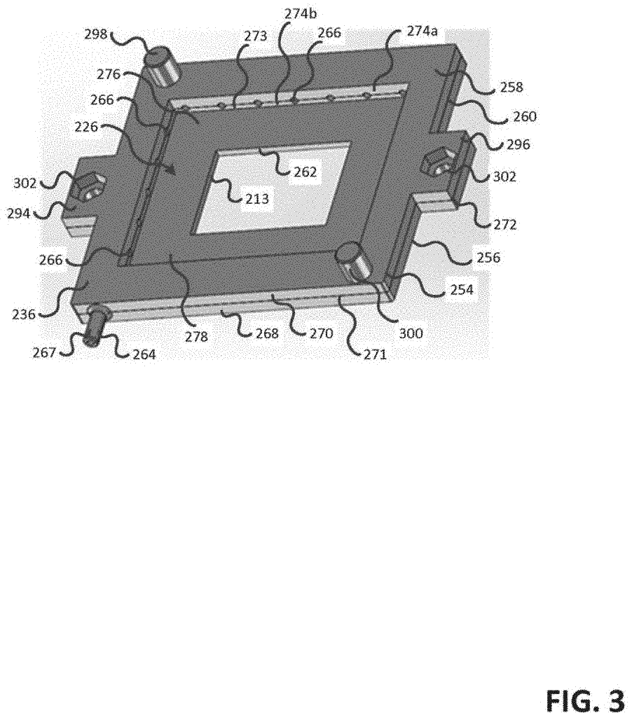

In the example shown, a de-humidified environment can be created directly above the surface of the chip 222 by inserting locating pins 298, 300 (the locating pins are more clearly shown in FIG. 3) of the cover 236 into holes defined by the chip clamp 222 or the system 200, thereby securing the cover 236 to the chip clamp 222. The manifold 244 may be attachable to the surface 253 of the system 200 via magnets. One of the flowlines 247 may be coupled to an air input within the system 200 via a quick connect coupler. The flowline 247 also couples the manifold 244 and the cover 236. The compressed air can flow to the cover 236 via the flowline 247 and the manifold 244. In the example shown, the pressure of the compressed air flowing to the cover 236 is adjustable by rotating the actuator 250. In some examples, the actuator 250 is positioned to a flow rate that allows dehumidification of the chip 22 at a threshold temperature. The temperature of the system 200 and/or the temperature immediately adjacent the chip 216 may be adjusted using, for example, the interface 154 of the system 200. In an example, after the threshold temperature within the system 200 is satisfied, a steady flow of air is continuously directed across a surface of the chip 222 throughout imaging and/or OptoElectroPositioning (OEP) cell manipulation experiments.

FIG. 3 illustrates an isometric bottom-view of the cover 236. In the example shown, the cover 236 is rectangular and includes a planar body 254 having a top surface 256 (hidden in FIG. 3), a bottom surface 258, and an outer edge surface 260. A central opening 213 defines an inner edge surface 262. The central opening 213 is rectangular, which conforms to a desired field of view of the imaging system 112 to capture the desired target area of the chip 216. However, the central opening 213 may be a different shape such as, for example, oval, triangular or any other shape that allows the imaging data of the associated chip 216 to be obtained. The shape of the central opening 213 can correspond to the shape formed by the outer edge surface 260, as shown. Alternatively, the shape of the central opening 213 may be different than the shape formed by the outer edge surface 260. For example, the central opening 213 may be circular and the outer edge surface 260 may form a square.

The cover 236 also includes a fluid inlet 264 and a plurality of fluid outlets 266. The fluid inlet 264 extends into the body 254 from the outer edge surface 260 between the top surface 256 and the bottom surface 258 and is formed by a male interface 267. The male interface 267 extends substantially perpendicularly from the outer edge surface 260 and has a circular cross-section. However, the inlet 264 may be differently formed. As an example, the inlet 264 can be formed as a port that receives a male adapter of the flowline 247.

The fluid outlets 266 are in fluid communication with the fluid inlet 264 via flow paths within the cover 236 and are arranged to exhaust gas out of the central opening 213. Specifically, the fluid outlets 266 are to flow the gas over a top surface of an associated chip 216 to reduce the likelihood of condensation and/or ice forming and interfering with the imaging procedure.

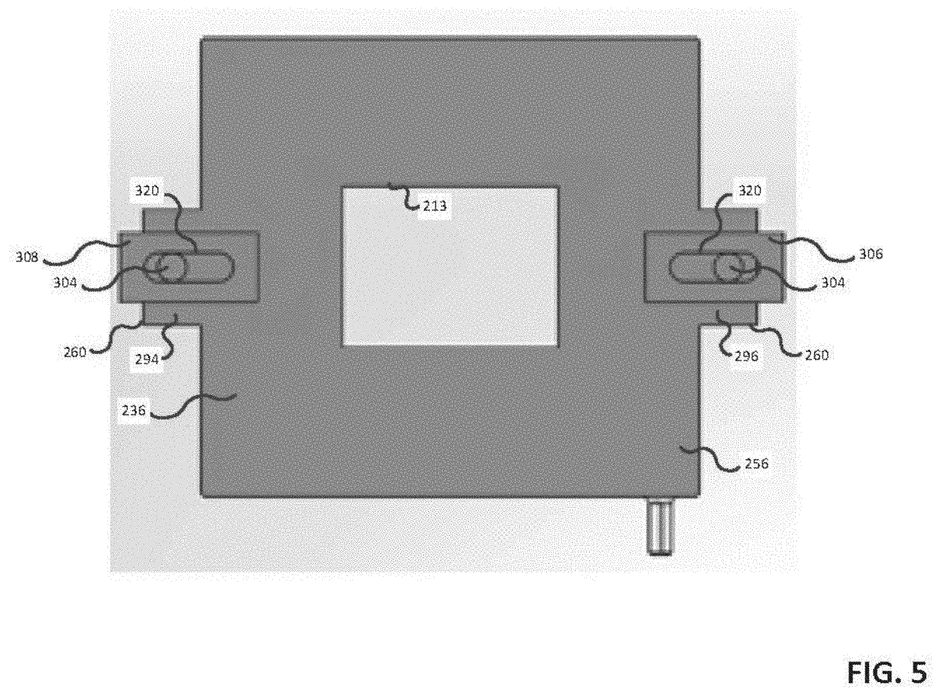

In the illustrated example, the cover 236 includes a first layer 268 and a second layer 270. To secure the first and second layers 268, 270 together, the layers 268, 270 may include mating structures. As an example, the first layer 268 can include protrusions (male structures) that extend from a mating surface 271 of the first layer 270 and an adjacent mating surface 272 of the second layer 270 can define apertures (female structures). When the first and second layers 268, 270 are stacked, the protrusions and the apertures align to allow the protrusions to be received within the apertures and for the layers 268, 270 to be coupled together. The interaction between the protrusions and the apertures may form a snap-fit, friction fit, press fit, or other connection. While the first layer 268 is mentioned potentially including protrusions and the second layer 270 is mentioned potentially including apertures, alternatively, the first layer 268 and/or the second layer 270 may include either of the protrusions or the apertures or may be held together in other ways (e.g., adhesive). Furthermore, in other examples such as the one shown in FIGS. 3-5, the layers 268, 270 can be held together via fasteners 204 (the fasteners 304 are best shown in FIG. 5). While the cover 236 is illustrated including the first and second layers 268, 270, the cover 236 may alternatively include a single layer and may be formed using, for example, additive manufacturing techniques or traditional machining techniques. Some traditional machining techniques include, for example, drilling, or milling a solid piece of material.

The second layer 270 and a portion 273 of the first layer 268 include inner walls 274a, 274b. The inner walls 274a, 274b define a central recess 226 in the bottom of the cover 236. The central recess 226 is shaped similar to but larger in dimension than the central opening 213. The central recess 226 may be sized such that when the cover 236 is positioned adjacent the chip 216, the chip 216 is positioned (or at least substantially positioned) within a dimensional envelope of the central recess 226. Alternatively, only a portion of the chip 216 is positioned within the dimensional envelope of the central recess 226 when the cover 236 is positioned adjacent thereto or the chip 216 is entirely outside of the dimensional envelope of the central recess 226.

In the example shown, the cover 236, the central opening 213, and the central recess 226 are rectangular (e.g., square) and may be sized to be positioned about a correspondingly sized/rectangular one of the chips 216. Additionally, to define the central recess 226, the first layer 268 defines a mask portion 276 that cantilevers inward toward the center of the cover 236 over the central recess 226 and terminates at the inner edge surface 262 of the central opening 213. So configured when the cover 236 is disposed on the chip 216 as shown in FIG. 2, the inner walls 274a, 274b may be positioned along the edges (e.g., outer edges) of the chip 216, thereby aligning the cover 236 in position, while the mask portion 276 extends at least partly over the chip 216 without obstructing the target area of the chip 216 to be captured by the imaging system 212.

The fluid outlets 266 are defined by the inner walls 274a, 274b and are outwardly spaced relative to the inner edge surface 262 of the central opening 213. Thus, the fluid outlets 266 are arranged to flow gas from the edges of the chip 216, beneath the mask portion 276 of the first layer 168, and toward a center of the chips 216, out through the central opening 213, so it can be understood that the mask portion 276 and the inner walls 274a, 274b define a chamber 278 (e.g., a micro-chamber) above the chip 216. The chamber 278 contributes to a local environment (e.g., the environment 132) about the chip 216 that may be controlled using the local air conditioner 206. Meaning, at least the mask portion 276 serves to restrict the flow of gas to the intended local environment immediately above and adjacent the chip 216, while simultaneously allowing the imaging system 112 to capture unobstructed images through the central opening 213,

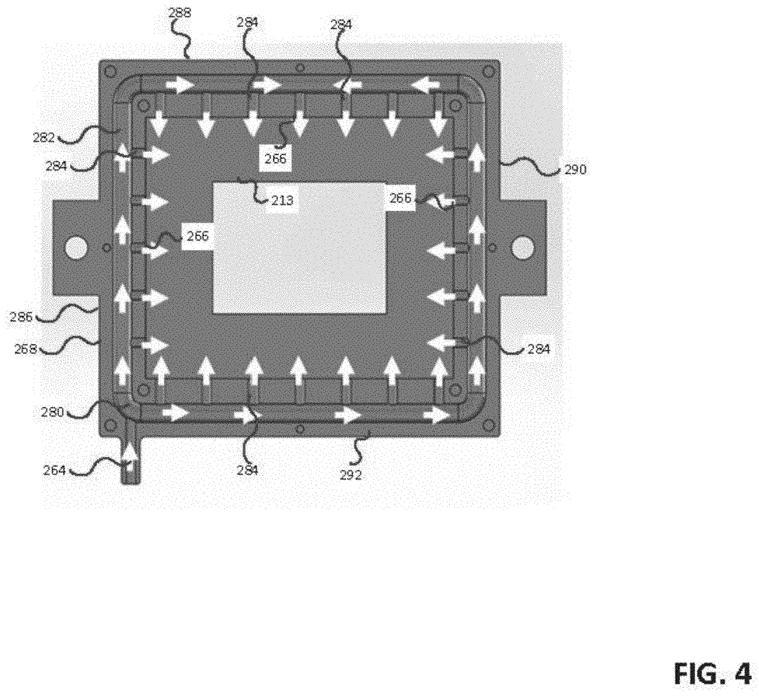

To illustrate further, FIG. 4 shows a plan-bottom view of the first layer 268. A plurality of fluid channels 280 are defined by the first layer 268. In the example shown, the fluid channels 280 include a perimeter fluid channel 282 and a plurality of transverse fluid channels 284. The perimeter fluid channel 282 is fluidly coupled to the fluid inlet 264 and follows in a square (or rectangular) pattern along sides 286, 288, 290, 292 of the first layer 268. In the example shown, the transverse fluid channels 284 are fluidly coupled to extend radially inward from the perimeter fluid channel 282 to the fluid outlets 266. Thus, the transverse fluid channels 284 flow gas from the perimeter fluid channel 282 to an associated respective one of the fluid outlets 266. The transverse fluid channels 284 are substantially equally spaced from one another such that the transverse fluid channels 284 on the first and third sides 289, 290 of the first layer 268 are mirror images of one another and the transverse fluid channels 284 on the second and fourth sides 288, 292 of the first layer 268 are mirror images of one another. However, the transverse fluid channels 284 may be positioned in other ways.

Similarly, while not shown, the second layer 270 includes a plurality of fluid channels having a perimeter fluid channel and a plurality of transverse fluid channels. The fluid channels 280 of the first layer 268 are mirror images of the fluid channels of the second layer 270 such that when the first and second layers 268, 270 are stacked, fluid channels are defined that form the fluid outlets 266. Alternatively, one of the layers 268, 270 may include grooves forming the fluid channels and the other of the layers 268, 270 may have a flat or non-grooved surface that forms a side of the fluid channels. The fluid channels and the fluid outlets 266 have a circular cross-section. However, the fluid channels and/or the fluid outlets 266 may have another cross-section. For example, the cross-section may be oblong, square, rectangular, etc.

Referring back to FIG. 3, when the first layer 268 and the second layer 270 are positioned immediately adjacent one another (i.e., stacked), the fluid channels 280 including the perimeter fluid channel 282 and the transverse fluid channels 284 of the first and second layers 268, 270 are positioned between the layers 268, 270. The cover 236 of FIG. 3 also includes a plurality of flanges 294, 296 and a plurality of locating pins 298, 300. The flanges 294, 296 may be used to secure the cover 236 adjacent one of the chips 216 and the locating pins 298, 300 may be used to position and/or secure the cover 236 relative to one of the chips 216. The locating pins 298, 300 may be received within apertures defined by the system 200 and/or the chip clamp 222. In the example shown, the flanges 294, 296 define apertures 302 that receive the fasteners 304 (the fasteners are best shown in FIG. 5) that are described in more detail in connection with FIG. 5.

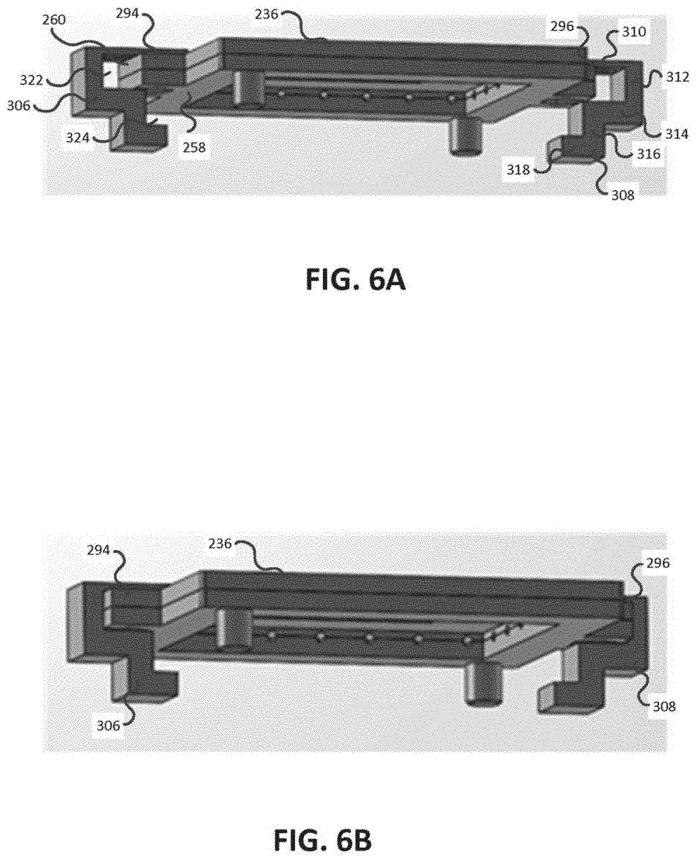

FIG. 5 illustrates a plan-top view of the cover 236. A plurality of cover clips 306, 308 (e.g., sliding clamps) are included. The cover clips 306, 308 each include a slot 320. Fasteners 304 are received through the apertures 302 in the flanges 294, 296 and within a respective one of the slots 320. An interaction between each fastener 304 and each slot 320 guides the relative movement between the cover clips 306, 308 and the fasteners 304, as shown in FIGS. 6A and 6B. Additionally or alternatively, the fasteners 204 may secure the layers 268, 270 together.

FIGS. 6A and 6B are isometric bottom-up views of the cover 236 and the cover clips 306, 308. The cover clips 306, 308 include first, second, third, fourth, and fifth legs 310, 312, 314, 316, 318. The first, second and third legs 310, 312, 314 are arranged in a C-shape and define a first groove 322. In the example shown, the first grooves 322 receive the flanges 294, 296 and, thus, the outer edge surface 260 of the cover 236 to assist in maintaining the cover 236 in its assembled or stacked state or, more generally, to assist in maintaining the position of the cover 236 to allow the cover 236 to form a border (or frame) about the chip 216. In this configuration of the cover clips 306, 308, the fourth and fifth legs 316, 318 of the chip clips 306, 308 are arranged in an L-shape extending downward from the third leg 314 and form second grooves 324 with the bottom surface 258 of the cover 236. The second grooves 324 are adapted to receive a portion of the chip clamp 202 and/or an adjacent structure to secure the cover 236 adjacent the associated chip 204.

FIG. 6B illustrates the flanges 294, 296 fully positioned within the first groove 322 of the cover clips 306, 308. In the position shown in FIG. 6B, the cover clips 306, 308 are capable of receiving a portion of the chip clamp 202 and/or an adjacent structure to secure the cover 236 adjacent the associated chip 204. To remove the cover 236 from being secured adjacent the chip clamp 202, the cover clips 306, 308 are moved outwardly to the position shown in FIG. 6A. Thus, using the disclosed examples, the covers 236 may be easily installed and uninstalled and may not require the existing cellular analysis system to be modified.

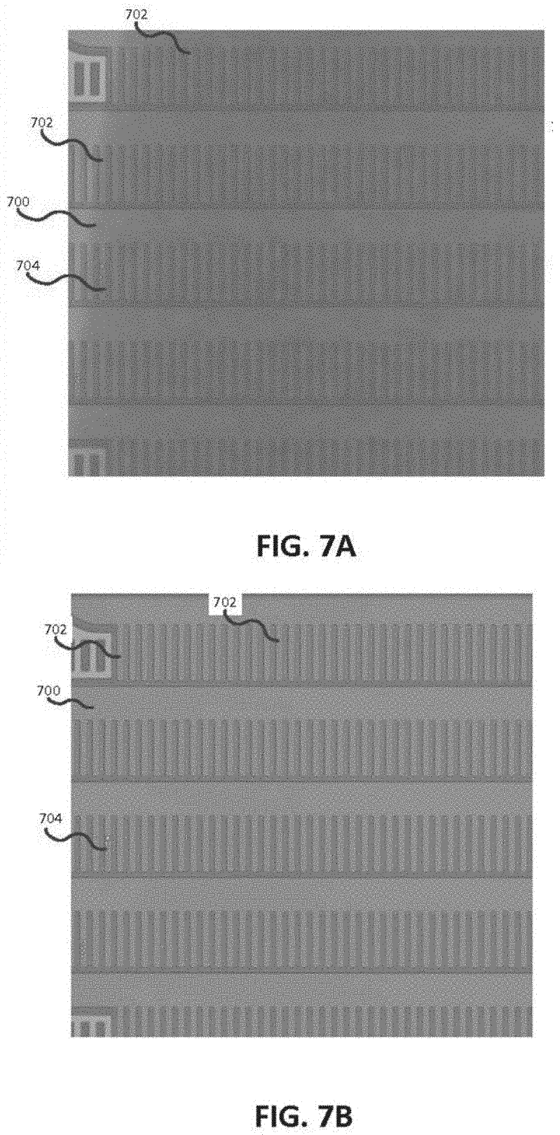

FIG. 7A illustrates a chip 700 having a plurality of wells 702 that is covered by condensation and/or frost. The condensation and/or the frost makes identifying the cells 704 within the wells 702 more difficult.

FIG. 7B illustrates the chip 700 with the condensation and/or frost removed (or reduced) after using the example covers disclosed herein. Without the condensation and/or the frost covering the wells 702, the cells 704 may be more easily identifiable.

In other embodiments, the present invention is directed to a method for improving the viability of cell which is to be subjected to optoelectronic positioning (OEP) comprising performing the OEP at a temperature below dew point such that the cell can be visualized while the cell is being loaded, wherein the device of the presently claimed invention is utilized in order to decrease condensation on a chip in a system for performing cellular analysis. In certain embodiments, the OEP is performed at a temperature selected from the group consisting of about 3° C., about 4° C., about 5° C., about 6° C., about 7° C., about 8° C., about 9° C., about 10° C., about 10.5° C., about 11° C., about 12° C., about 13° C., about 14° C., about 15° C., about 16° C., about 17° C., about 18° C., about 19° C., about 20° C., about 21° C., and about 22° C.

From the foregoing, it will be appreciated that the above disclosed apparatus, methods and articles of manufacture enable cellular analysis to be conducted below the dew point of ambient air without or with a reduced amount of condensation forming adjacent the chips on which the analysis is being conducted, by providing for movement of air (either sporadically or continuously) in the local environment adjacent to the chips by the unique covers. Thus, the disclosed examples enable lower temperatures such as, for example, between about 2° C. and 8° C. to be maintained for extended periods while obtaining unobstructed cellular imaging data. As a result, cellular analysis and/or receptor/ligand assay may be executed at lower temperatures allowing for novel antibodies to be potentially discovered. Additionally, when the local air conditioners are not integral to the cellular analysis systems and, thus, are removable, the covers disclosed may be installed and/or removed relatively easily and, in some examples, without modifying the existing system.

Optoelectronic Positioning (OEP) and fluorescent imaging on the Berkeley Lights Beacon requires optical clarity through the glass surface of the nanofluidic chip. The presently claimed device enables OEP manipulation of objects and fluorescent data generation on the Berkeley Lights Beacon platform at temperatures below the specific dew point of water in the room by providing a steady evenly-dispersed flow of air across the surface of the chip while mounted on the nest. OEP induces a transient voltage gradient on the cells during the positioning process and this electrical current can have deleterious effects on mammalian cells in-vitro. In this set of experiments we have validated the hypothesis that reducing the temperature of the cells from 36° C. to 10.5° C. (enabled by the claimed device) during OEP loading of transduced human T cells leads to better cell survival and more effective antigen specific proliferation.

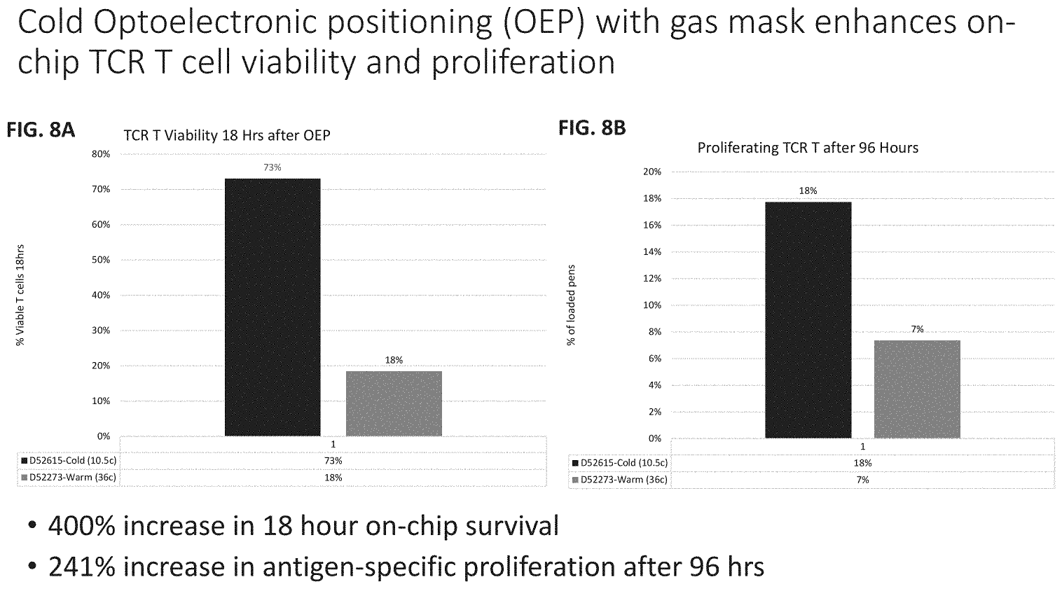

Normal donor human T cells were transduced with a GFP lentiviral construct encoding a TCR specific for an investigational cancer antigen. T cell cultures were expanded in Xuri bioreactors (GE) for 10 days, analyzed via FACS to confirm expression of the transduced TCR, and frozen down for long term storage in LN2. Vials containing transduced T cells (TCR T) were thawed, cultured in G-Rex plates (Wilson Wolf) at 36° C., 5% CO2 for greater than 3 days prior to being loaded onto the Berkeley Lights Beacon. The Beacon was initialized by loading 2 OS3500 nanofluidic chips (Berkeley Lights) into the nest hardware, wetting the chip per manufacturer's protocols, and flushing with growth media containing human AB serum. Gibco Dynabeads Human T-Activator CD3/CD28 (Thermofisher) were loaded into the pens using a combination of OEP and gravity. Excess unpenned beads were flushed out of the system to waste. Next, TCR T cells were stained with DAPI viability dye (Thermofisher) and manually loaded onto the 2 chips. The claimed device was installed over one of the Beacon nests containing a OS3500 and air supply was initiated allowing air to flow to the claimed device. Temperature of the claimed device nest was reduced to 10.5° C. while the nest without the claimed device was temperature controlled to 36° C. OEP pen loading of single viable TCR T expressing cells (DAPI−/GFP+) was then performed at both 10.5° C. and 36° C. temperature conditions using the Target Penning Selection (TPS) application of the Berkeley Lights Cell Analysis Suite (CAS) software. Unpenned TCR T were flushed out of the OS3500 chips to waste and images of each Field of View (FOV) of the chip containing cells and beads were captured using the Brightfield (BF), DAPI, and the FITC color cubes. Both chips were then removed from the Beacon and cultured on the Berkeley Lights Culture Station at a vertical orientation. Growth media was perfused through each chip at periodic intervals while the temperature was maintained at 36° C. overnight. The next day, each chip was returned to the Beacon, flushed with appropriate growth media containing DAPI dye, and incubated at 36° C. for 15 min. FOV images for both chips were again captured in BF, DAPI, and FITC cubes. Images were then analyzed and the number of pens scored for DAPI+/− as an indication of overall survival post OEP loading. The results (400% increase in 18 hour on-chip survival) are shown in FIG. 8A.

Normal donor human T cells were transduced with a GFP lentiviral construct encoding a TCR specific for an investigational cancer antigen. T cell cultures were expanded in Xuri bioreactors (GE) for 10 days, analyzed via FACS to confirm expression of the transduced TCR, and frozen down for long term storage in LN2. Vials containing transduced T cells (TCR T) were thawed, cultured in G-Rex plates (Wilson Wolf) at 36° C., 5% CO2 for greater than 3 days prior to being loaded onto the Berkeley Lights Beacon. T2 cells were transduced with an mCherry construct and cultured in 6-well culture plates (Corning) for greater than 2 weeks using culture media containing human AB serum and an antibiotic selection marker. OS3500 chips were prepared for loading under the different temperature conditions as previously described in the 18 hour survival study, above. T2-Red cells were pulsed with 10 uM of the TCR T specific peptide, stained with DAPI dye and manually loaded onto each OS3500 nest and penned via gravity. Briefly, the chips were removed from the nest hardware, held at a 90 degree angle inside the cabinet of the Beacon for 15 minutes, then returned to the Beacon where the excess unpenned T2-Red cells were washed to waste. After T2-Red loading, FOV images using BF, DAPI, and TRED cubes were acquired. Next, TCR T cells were stained with DAPI and manually loaded into 2 OS3500 chips as before. The claimed device was installed over one of the chips and the temperature was lowered to 10.5° C. OEP was performed on both chips using TPS and selecting for GFP+/DAPI− TCR T cells. Excess unpenned TCR T cells were flushed to waste and images taken in BF, DAPI, TRED, and FITC across all FOV of both chips. Both chips were then removed from the Beacon as cultured on the Culture Station as previously described. 96 hours after loading, each chip was returned to the Beacon, flushed with growth media containing DAPI dye, and imaged on the Beacon in the BF, DAPI, TRED, and FITC cube channels. Proliferation was scored by counting nanopens with no more than 2 cells DAPI−/GFP+ at the time of load and no less than 4 DAPI−/GFP+ TCR T cells at 96 hours. The results (241% increase in antigen-specific proliferation after 96 hours) are shown in FIG. 8B.

Further, while several examples have been disclosed herein, any features from any examples may be combined with or replaced by other features from other examples. Moreover, while several examples have been disclosed herein, changes may be made to the disclosed examples without departing from the scope of the claims.

We claim:

1. A device for conditioning an environment adjacent a chip in a system for performing cellular analysis, the device comprising:
a cover for being disposed adjacent the chip and comprising a planar body having a top surface, a bottom surface, and an outer edge surface, the cover comprising:
a central opening extending between the top surface and the bottom surface and bounded by an inner edge surface of the cover;
a fluid inlet extending into the body from the outer edge surface between the top surface and the bottom surface, the fluid inlet arranged to accept a gas to be delivered to the central opening; and
a plurality of fluid outlets defined in the inner edge surface and in fluid communication with the fluid inlet, the plurality of fluid outlets arranged to receive the gas from the fluid inlet and exhaust the gas into the central opening.

2. The device of claim 1, wherein the cover includes a first layer including the top surface and a second layer including the bottom surface.

3. The device of claim 2, wherein the first layer defines the central opening and includes the inner edge surface.

4. The device of claim 3, wherein the second layer includes inner walls that surround the central opening.

5. The device of claim 4, wherein the fluid outlets are defined by the inner walls.

6. The device of claim 5, wherein the fluid outlets are outwardly spaced relative to the inner edge surface of the central opening.

7. The device of claim 4, wherein a mask portion of the first layer extends between the inner walls and the central opening, the mask portion and the inner walls defining a chamber that covers the chip.

8. The device of claim 2, wherein a plurality of fluid channels are arranged between the first layer and the second layer, respective ones of the fluid outlets associated with the fluid channels.

9. The device of claim 8, wherein the first layer and the second layer are positioned adjacent one another to form the fluid channels therebetween.

10. The device of claim 1, wherein the cover includes a plurality of locating pins extending from the bottom surface, the locating pins arranged to be received adjacent the chip.

11. The device of claim 1, further comprising a plurality of cover clips having slots that receive portions of the outer edge surface of the cover, the cover clips to be arranged to secure the cover relative to the chip.

12. The device of claim 11, wherein the cover comprises a plurality of fasteners, the cover clips comprise slots, the fasteners are received within the slots.

13. A system for performing cellular analysis, comprising:
an enclosure;
an imaging system disposed within the enclosure;
a chip to carry cells for analysis within the enclosure;
a chip clamp to clamp the chip in place;
a local air conditioner arranged to reduce humidity immediately adjacent the chip; and
a controller to cause the imaging system to obtain imaging data of the cells on the chip.

14. The system of claim 13, wherein the local air conditioner includes a cover, the cover to be disposed adjacent the chip and defining a central opening, the imaging data of the cells to be obtained through the central opening.

15. The system of claim 14, wherein the cover includes a planar body having a top surface, a bottom surface, and an outer edge, the central opening extending between the top surface and the bottom surface and defining an inner edge surface.

16. The system of claim 15, wherein the cover further comprises a fluid inlet extending into the body from the outer edge between the top surface and the bottom surface and a plurality of fluid outlets in communication with the fluid inlet and arranged to exhaust a gas out of the central opening.

17. The system of claim 16, wherein the cover includes a first layer including the top surface and a second layer including the bottom surface, a plurality of fluid channels are arranged between the first layer and the second layer, respective ones of the fluid outlets associated with the fluid channels.

18. The system of claim 17, wherein the first layer defines the central opening and includes the inner edge surface and the second layer includes inner walls that surround the central opening and define the fluid outlets, a mask portion of the first layer extending between the inner walls and the central opening and the inner walls defining a chamber that covers the chip.

19. The system of claim 13, further comprising a second chip to carry cells for analysis within the enclosure and a second chip clamp to clamp the second chip in place, and wherein the local air conditioner is arranged to reduce humidity immediately adjacent the second chip.

20. The system of claim 19, wherein the local air conditioner includes a manifold arranged to direct a gas toward the chip and the second chip, the gas reducing the humidity immediately adjacent the chip and the second chip.

21. A method for improving the viability of cell which is to be subjected to optoelectronic positioning (OEP) comprising performing the OEP at a temperature below dew point such that the cell can be visualized while the cell is being loaded, wherein the device of claim 1 is utilized in order to decrease condensation on a chip in a system for performing cellular analysis.

22. The method of claim 21, wherein the OEP is performed at a temperature selected from the group consisting of about 3° C., about 4° C., about 5° C., about 6° C., about 7° C., about 8° C., about 9° C., about 10° C., about 10.5° C., about 11° C., about 12° C., about 13° C., about 14° C., about 15° C., about 16° C., about 17° C., about 18° C., about 19° C., about 20° C., about 21° C., and about 22° C.
